(19) United States
(12) Patent Application Publication
(10) Pub. No.: US 2026/0290992 A1
(43) Pub. Date: Sep. 24, 2026

(54) RELIEF VALVE

(71) Applicants: PACIFIC INDUSTRIAL CO., LTD., Ogaki-shi, Gifu-ken (JP); TOYOTA JIDOSHA KABUSHIKI KAISHA, Toyota-shi, Aichi-ken (JP)

(72) Inventors: Yuki SUNAYAMA, Gifu-shi (JP); Kazuhiro KANAMORI, Gifu-shi (JP); Shigeyuki INOUE, Toyota-shi (JP); Junki SUGIMOTO, Nisshin-shi (JP)

(73) Assignees: PACIFIC INDUSTRIAL CO., LTD., Ogaki-shi, Gifu-ken (JP); TOYOTA JIDOSHA KABUSHIKI KAISHA, Toyota-shi, Aichi-ken (JP)

(21) Appl. No.: 19/471,965

(22) PCT Filed: Aug. 9, 2024
(86) PCT No.: PCT/JP2024/028662

§ 371 Date: Oct. 2, 2025

(30) Foreign Application Priority Data
Oct. 20, 2023 (WO) PCT/JP2023/038008
Mar. 27, 2024 (WO) PCT/JP2024/012445

(51) Int. Cl. H01M 50/333

(52) U.S. Cl. CPC H01M 50/333

(57) ABSTRACT

A relief valve includes: a base part fixed to a battery pack and having a valve hole configured to discharge gas in the battery pack to outside; a support member included in the base part and extending from an inner surface or an opening edge of the valve hole into the valve hole or an extended space of the valve hole; a valve body covering the valve hole from an outer side, supported by the support member, and configured to operate so as to move away from the valve hole to the outer side in response to an increase in pressure in the battery pack; and a shielding member included in the base part and covering the support member from the battery pack side.

### TECHNICAL FIELD

The present disclosure relates to a relief valve that is attached to a battery pack.

### BACKGROUND ART

As this type of relief valve, a relief valve is known in which a valve body is supported by a base part that is fixed to a battery pack (see, for example, Patent Document 1).

### RELATED ART DOCUMENTS

### Patent Documents

Patent Document 1: JP 2021-101123 A (paragraph [0026], FIG. 3)

### SUMMARY OF THE INVENTION

### Problems to be Solved by the Invention

In a battery pack, a battery cell accommodated therein may rupture, and high-temperature gas may be discharged from a relief valve. To solve this problem, the present application discloses a technique that enables improvement of the durability of a relief valve against the above-described high-temperature gas as compared with the conventional art.

### Means of Solving the Problems

One aspect of the invention is a relief valve including: a base part fixed to a battery pack and having a valve hole configured to discharge gas in the battery pack to outside; a support member included in the base part and extending from an inner surface or an opening edge of the valve hole into the valve hole or an extended space of the valve hole; a valve body covering the valve hole from an outer side, supported by the support member, and configured to operate so as to move away from the valve hole to the outer side in response to an increase in pressure in the battery pack; and a shielding member included in the base part and covering the support member from the battery pack side.

### BRIEF DESCRIPTION OF THE DRAWINGS

FIG. 1 is a perspective view of a relief valve according to a first embodiment.

FIG. 2 is an exploded perspective view of the relief valve.

FIG. 3 is a plan view of a base part.

FIG. 4 is a perspective view of the base part as viewed obliquely from above.

FIG. 5 is a perspective view of the base part as viewed obliquely from below.

FIG. 6 is a perspective view of a packing.

FIG. 7A is a perspective view of an engagement portion between an upper packing and the base part, and FIG. 7B is a perspective view of an engagement portion between a lower packing and the base part.

FIG. 8A is a cross-sectional view of the base part before being attached to a battery pack, and FIG. 8B is a cross-sectional view of the base part that has been attached to the battery pack.

FIG. 9 is a perspective view of a first support member.

FIG. 10 is a cross-sectional view of the first support member.

FIG. 11 is a cross-sectional side view of the relief valve that has been attached to the battery pack.

FIG. 12 is a cross-sectional side view of a relief valve according to a second embodiment.

FIG. 13 is a perspective view of an engagement portion between an upper packing and a base part of a relief valve according to a third embodiment.

FIG. 14 is a cross-sectional view of the engagement portion between the packing and the base part according to the third embodiment.

FIG. 15A is a cross-sectional view of a first modification of the third embodiment, and FIG. 15B is a cross-sectional view of a second modification of the third embodiment.

FIG. 16 FIG. 16A is a perspective view of a first support member according to the third embodiment, and FIG. 16B is a perspective view of a shielding member according to the third embodiment.

FIG. 17 is a perspective view of a first support member according to a fourth embodiment.

FIG. 18A is a perspective view of a shielding member according to a fifth embodiment, and FIG. 18B is a perspective view of a shielding member according to a sixth embodiment.

FIG. 19A is a cross-sectional view of a first modification of the first support member, and FIG. 19B is a cross-sectional view of a second modification of the first support member.

FIG. 20A is a cross-sectional view of a first modification of the second support member, and FIG. 20B is a cross-sectional view of a second modification of the second support member.

### MODE FOR CARRYING OUT THE INVENTION

### First Embodiment

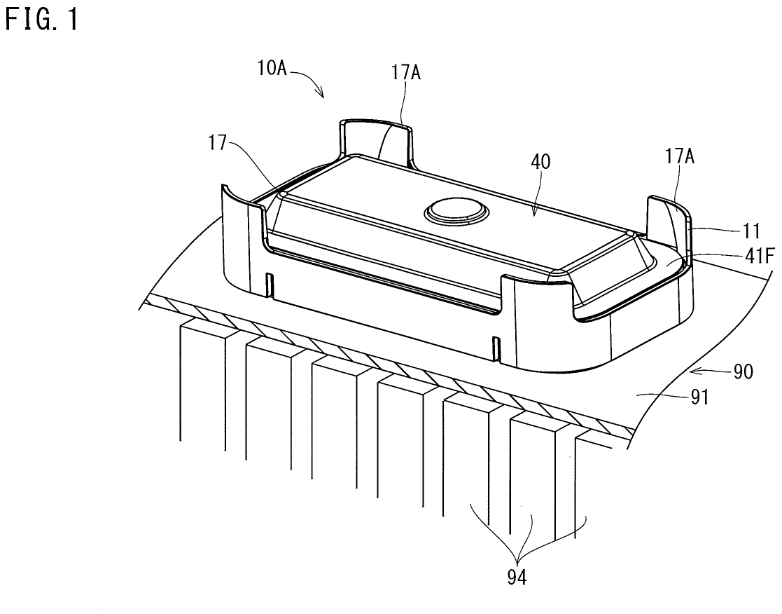

A relief valve 10A according to a first embodiment will be described with reference to FIGS. 1 to 11. The relief valve 10A is fixed to a battery pack 90 illustrated in FIG. 1. The battery pack 90 is, for example, a container that accommodates a plurality of battery cells 94 and protects the battery cells from water, dust, and the like, and is mounted on a vehicle such as a hybrid vehicle or an electric vehicle. The relief valve 10A is attached to an upper surface of the battery pack 90 which is partially illustrated in FIG. 1.

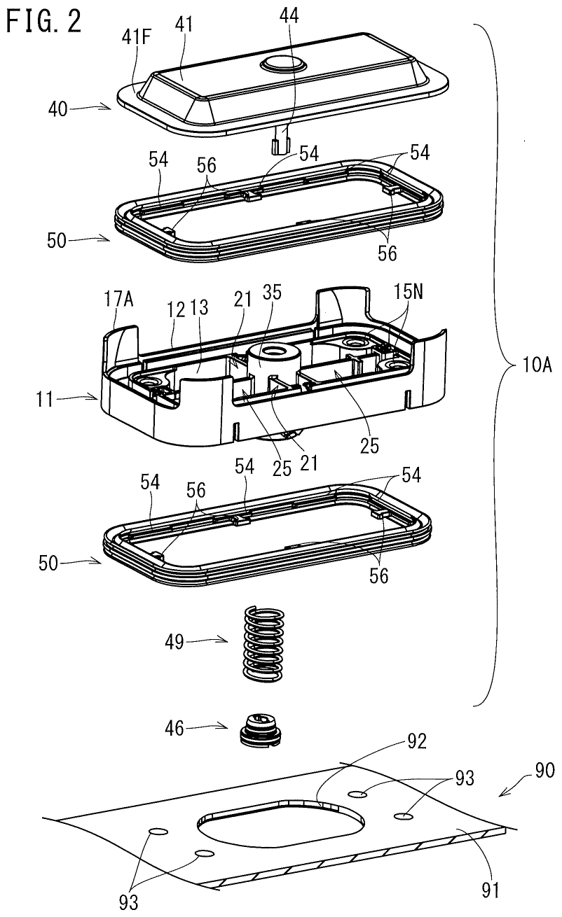

In order to attach the relief valve 10A, one discharge hole 92 and a plurality of attachment holes 93 are formed in an upper wall 91 of the battery pack 90 as illustrated in FIG. 2. The discharge hole 92 has, for example, an oval shape, and the plurality of attachment holes 93 are disposed, for example, in pairs on both sides of the discharge hole 92 in a longitudinal direction.

The relief valve 10A of the present embodiment is disposed on the upper surface of the battery pack 90, but may be disposed at a location other than the upper surface. The battery pack 90 may be made of metal or resin. In addition, the battery pack 90 may be a rigid body or may be a bag-shaped soft body that is easily deformed. The discharge hole 92 of the battery pack 90 of the present embodiment has an oval shape, but may have any shape such as a circular shape, an elliptical shape, a polygonal shape, or an asymmetric irregular shape.

The relief valve 10A includes a base part 11 that is fixed to the battery pack 90. Hereinafter, for convenience of explanation, the orientation and direction of the “upper side, lower side, lateral side, and the like of the relief valve 10A in FIG. 1” are simply referred to as “upper side, lower side, lateral side, and the like of the relief valve 10A”, but the relief valve 10A may be used in any orientation and direction.

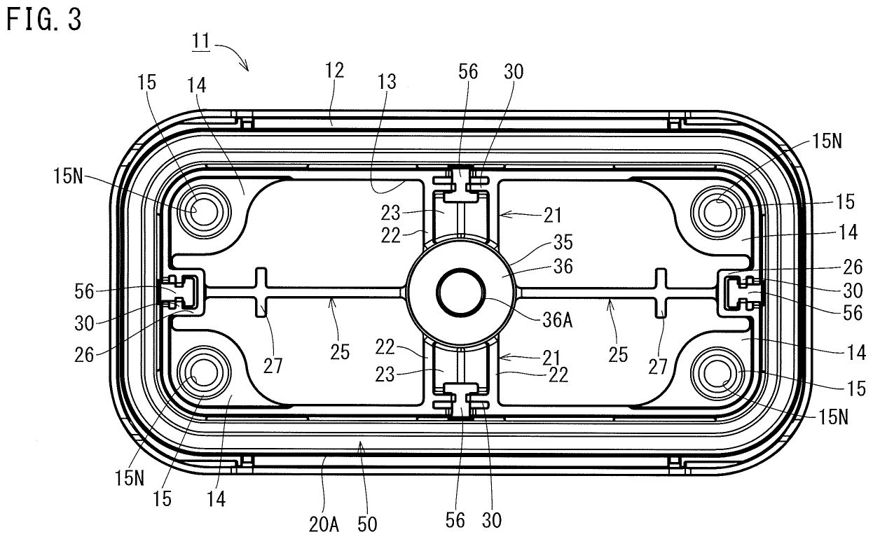

The base part 11 is, for example, a resin insert-molded component including a nut 15 made of metal, and includes a frame-shaped base main body portion 12 in which four corners of a rectangle are chamfered in an arc shape as illustrated in FIG. 3. The inside of the base main body portion 12 serves as a valve hole 13, and corner projecting walls 14 protrude from the four corners of the base main body portion 12 into the valve hole 13. The above-described nut 15 is embedded in each of the corner projecting walls 14, and a threaded hole 15N of each nut 15 vertically passes through the corner projecting wall 14. A plurality of bolts (not illustrated) passing through the plurality of attachment holes 93 from the inside of the battery pack 90 (see FIG. 2) are screwed into the plurality of threaded holes 15N, to fix the base part 11 to the battery pack 90.

The planar shape of the base main body portion 12 is not limited to the rectangle, and may be a shape such as a circle, an ellipse, or a polygon other than the rectangle. The base part 11 may include a plurality of through holes instead of the plurality of threaded holes 15N, and a plurality of bolts passing through the through holes may be screwed into nuts that are laid on an upper surface of the base part 11 or an inner surface of the battery pack 90. The base part 11 may also be fixed to the battery pack 90 with a rivet. Furthermore, a plurality of elastic engagement pieces may protrude from the base part 11 and may engage with an opening edge of the discharge hole 92 or opening edges of the attachment holes 93 of the upper wall 91, instead of providing a fastener such as a bolt or a rivet, for example. The base part 11 may also be fixed to the battery pack 90 with an adhesive.

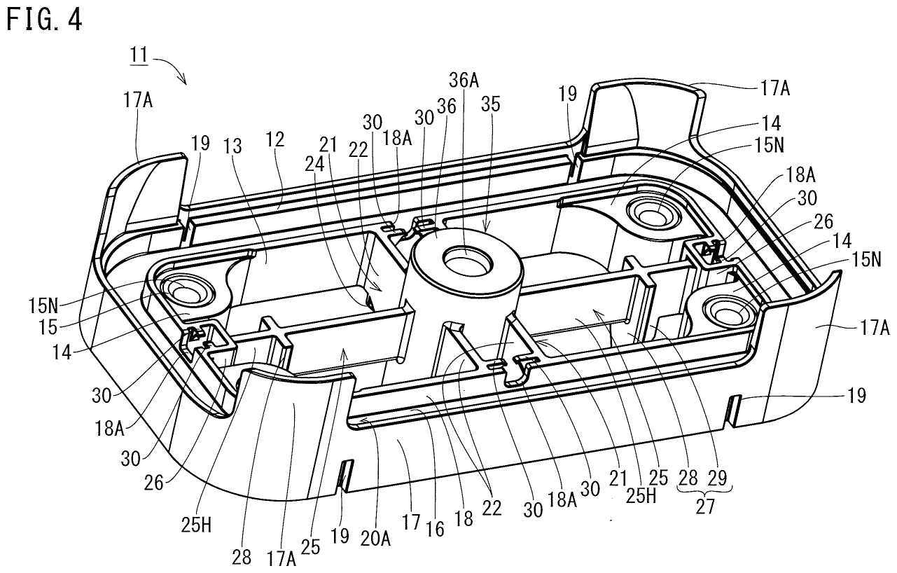

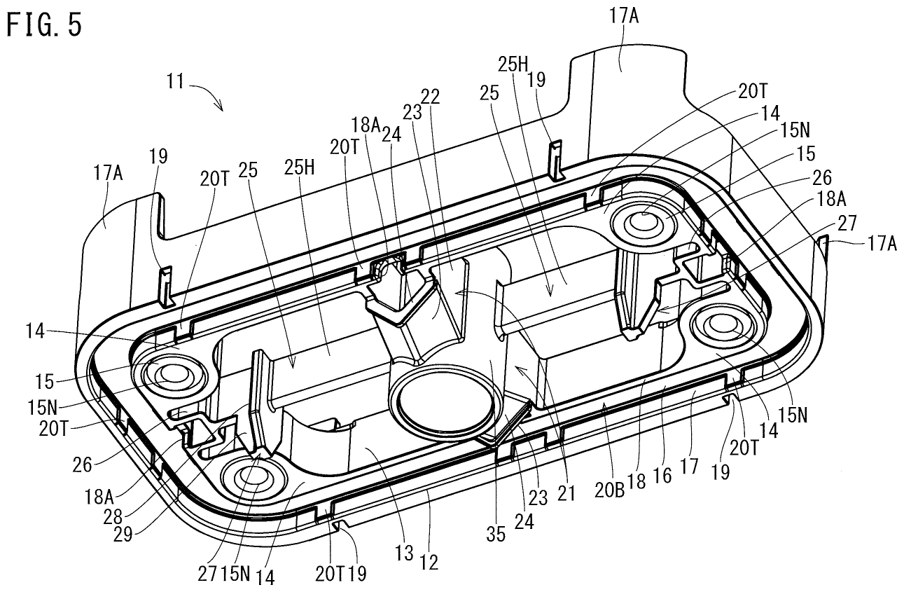

As illustrated in FIGS. 4 and 5, a pair of packing receiving grooves 20A and 20B are formed on an upper surface and a lower surface of the base main body portion 12, respectively. Specifically, the base main body portion 12 includes an upper-lower partition wall 16 having a flat-plate frame shape located at an intermediate portion in a vertical direction of the base main body portion 12, and an outer peripheral wall 17 and an inner peripheral wall 18 each having an annular shape and facing each other with the upper-lower partition wall 16 interposed therebetween in a width direction. The annular packing receiving grooves 20A and 20B surrounded on three sides by the upper-lower partition wall 16, the outer peripheral wall 17, and the inner peripheral wall 18 are formed on both the upper and lower sides with respect to the upper-lower partition wall 16.

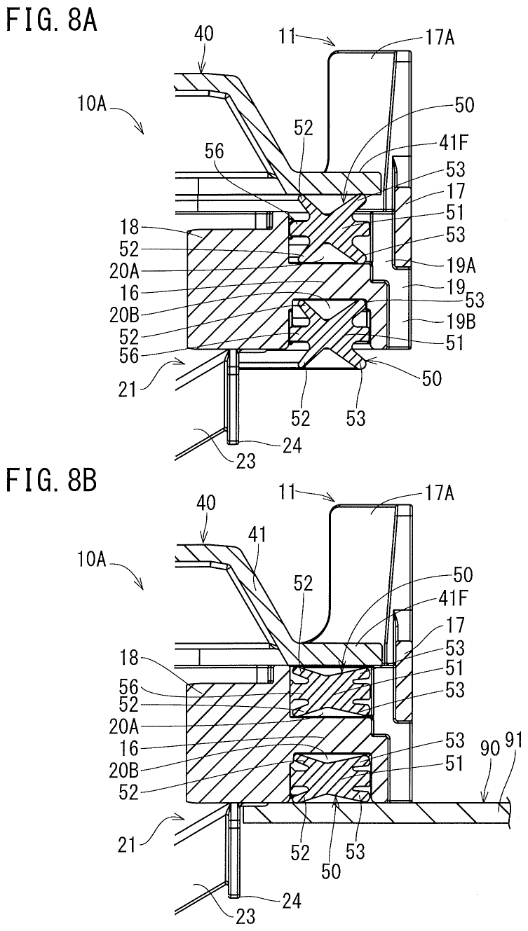

As illustrated in FIG. 4, a plurality of drainage grooves 19 are formed at a plurality of locations in a peripheral direction of the outer peripheral wall 17. As illustrated in FIG. 8A, each drainage groove 19 includes an upper groove 19A extending in the vertical direction on an inner side surface of the outer peripheral wall 17 at the packing receiving groove 20A on the upper side and having a lower end reaching an intermediate position in the vertical direction of the upper-lower partition wall 16, and a lower groove 19B extending from a lower end of the outer peripheral wall 17 to the intermediate position in the vertical direction on an outer surface of the outer peripheral wall 17. A lower end portion of the upper groove 19A and an upper end portion of the lower groove 19B communicate with each other. As a result, even if water enters the packing receiving groove 20A on the upper side, water is discharged to the outside through the drainage groove 19.

As illustrated in FIGS. 4 and 5, engagement grooves 18A are formed in both upper and lower end portions of the inner peripheral wall 18 at the center of each side of the rectangle that is the planar shape of the inner peripheral wall 18. Each engagement groove 18A is formed by cutting out a part of the inner peripheral wall 18 in a substantially quadrangular shape from an upper end or a lower end of the inner peripheral wall 18 to a position close to the upper-lower partition wall 16.

As illustrated in FIG. 5, a plurality of stepped projections 20T slightly protruding stepwise from inner surfaces of the outer peripheral wall 17 and the inner peripheral wall 18 are provided at a plurality of positions in the peripheral direction of the packing receiving groove 20B on the lower side.

A pair of packings 50 illustrated in FIG. 2 are received in the packing receiving grooves 20A and 20B. Each packing 50 has a rectangular frame shape corresponding to the planar shape of the base main body portion 12 as a whole. As illustrated in FIG. 8A, the packing 50 has a cross-sectional shape that is plane-symmetrical in the vertical direction, and includes an inner lip 52 and an outer lip 53 on each of upper and lower surfaces of a flat plate portion 51. The pair of upper and lower inner lips 52 respectively protrude obliquely upward and obliquely downward toward the inside from an intermediate portion in a width direction of the flat plate portion 51, and the pair of upper and lower outer lips 53 respectively protrude obliquely upward and obliquely downward toward the outside from the intermediate portion in the width direction of the flat plate portion 51. The outer lips 53 are thicker than the inner lips 52, and distal ends of both the inner lips 52 and the outer lips 53 have an arc cross-sectional shape.

The packing 50 is made of elastomer having higher heat resistance than resin forming the base part 11 and a valve body 40 described later. The packing 50 may be made of any material that is softer than the base part 11 and the valve body 40.

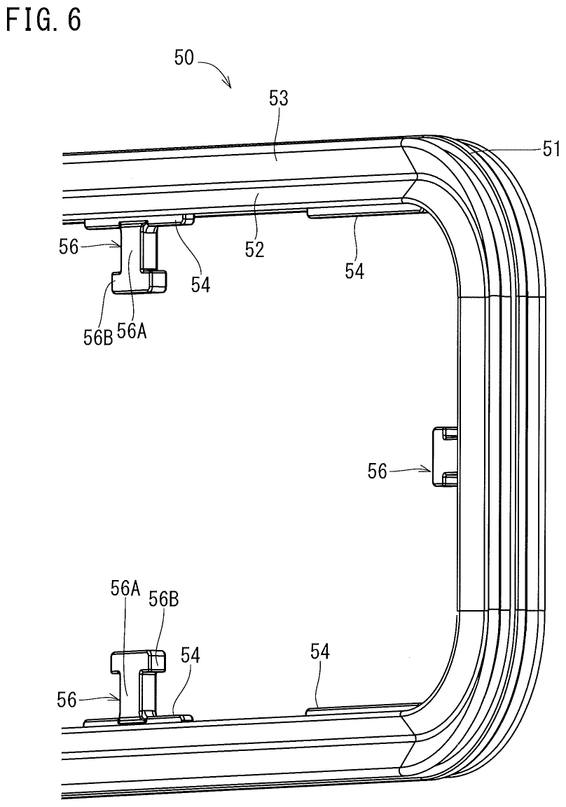

As illustrated in FIG. 2, a plurality of inner protruding portions 54 protrude inward from a plurality of positions in the peripheral direction of the packing 50. The plurality of inner protruding portions 54 are formed by slightly extending a part of the flat plate portion 51 inward in a stepped manner. Some of the plurality of inner protruding portions 54 are disposed at the center of a pair of long sides and the center of a pair of short sides of the packing 50, and an engagement projection 56 extends inward from the center of each of such inner protruding portions 54. As illustrated in FIG. 6, the engagement projection 56 has a T-shaped planar shape, and includes a longitudinal portion 56A extending from the inner protruding portion 54 and a head portion 56B that is a lateral portion perpendicular to a distal end portion of the longitudinal portion 56A. The engagement projection 56 is thicker than the flat plate portion 51 and the inner protruding portion 54.

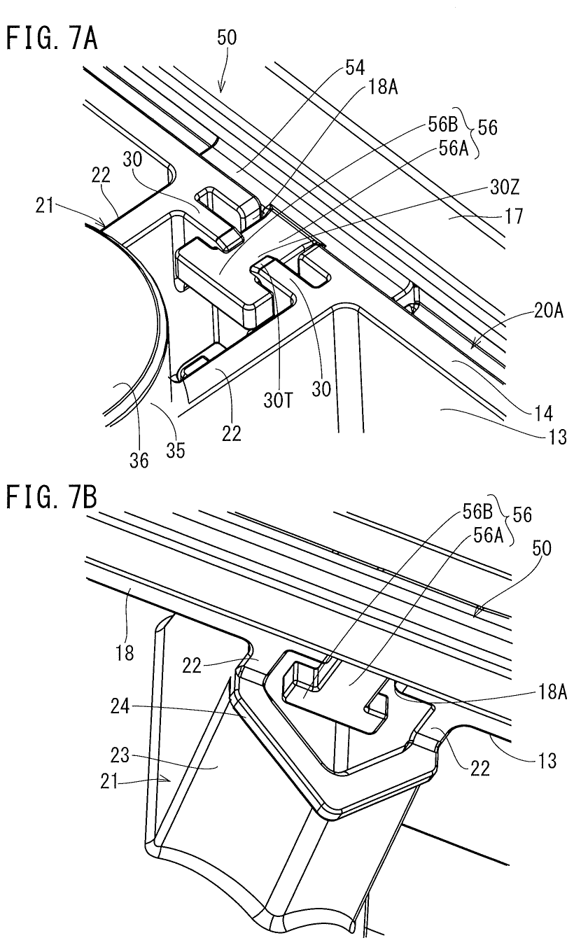

The pair of packings 50 are received in the upper and lower packing receiving grooves 20A and 20B, and the engagement projections 56 of each packing 50 engage with the engagement grooves 18A (see FIGS. 7A and 7B). As illustrated in FIG. 8A, before the base part 11 is fixed to the battery pack 90, the inner lip 52 and the outer lip 53 on the lower side of the lower packing 50 protrude downward from the packing receiving groove 20B. As illustrated in FIG. 8B, by fixing the base part 11 to the battery pack 90, the entire lower packing 50 is accommodated in the packing receiving groove 20B. Similarly, the upper packing 50 is also pushed by the valve body 40 from above, and is entirely accommodated in the packing receiving groove 20A.

The packing 50 is not limited to the cross-sectional shape described above, and for example, may have a circular cross section. An O-ring may be used as the packing. In addition, sealing between the base part 11 and the upper wall 91 may be performed using an adhesive without providing the packing 50 between the base part 11 and the upper wall 91. Furthermore, between the base part 11 and the valve body 40, the packing may be provided not in the base part 11, but in the valve body 40.

The packing 50 of the present embodiment does not have to have a symmetrical cross-sectional shape. Specifically, the inner lip 52 and the lower lip 53 may be formed on only one of the upper side or the lower side. In addition, although the outer lip 53 is thicker than the inner lip 52, the inner lip 52 may be thicker than the outer lip 53 or may have the same thickness as the outer lip 53. Furthermore, the engagement projections 56 do not have to be provided.

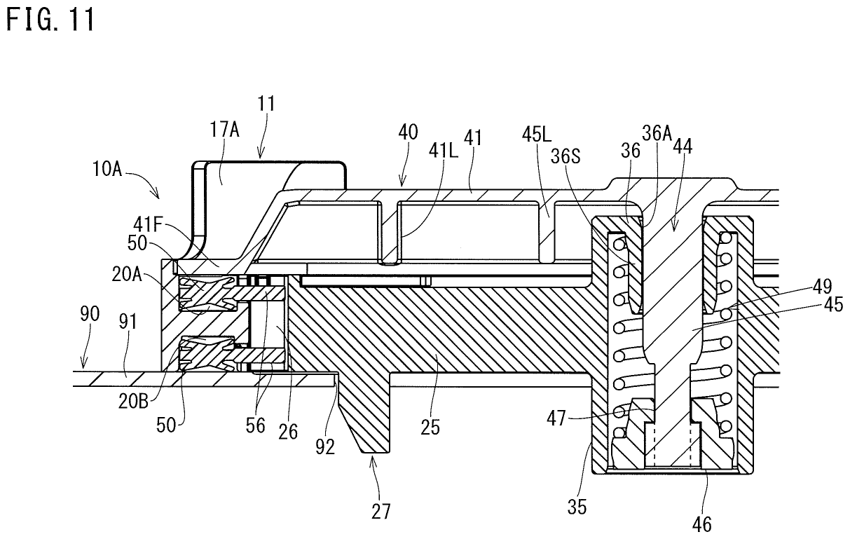

As illustrated in FIG. 3, a support sleeve 35 is provided in the base part 11 at the center of the planar shape within the valve hole 13, and is supported by first and second support members 21 and 25 that are extended between the support sleeve 35 and an inner surface of the valve hole 13. As illustrated in FIG. 11, the support sleeve 35 includes a ceiling wall 36 at an upper end of a cylindrical body extending in the vertical direction. An inner cylindrical portion 36S having a smaller diameter and a shorter length than the support sleeve 35 is suspended from a central portion of the ceiling wall 36. A support hole 36A passing through the inner cylindrical portion 36S opens at the center of an upper surface of the ceiling wall 36. The valve body 40 is supported by the support sleeve 35.

As illustrated in FIG. 2, the valve body 40 is, for example, a resin-molded component, and has a thin dish-shaped valve body main body 41 that bulges upward as a whole and has an open lower surface. As illustrated in FIG. 11, an outer edge portion of the valve body main body 41 forms a flange portion 41F having a flat-plate frame shape that exactly fits in the packing receiving groove 20A on the upper side of the base part 11. A cylindrical rib 45L is suspended from the center of the lower surface of the valve body main body 41, and a latticed rib 41L is provided around the cylindrical rib 45L.

A shaft main body 45 is suspended from a central portion of the lower surface of the valve body main body 41 inside the cylindrical rib 45L, and the shaft main body 45 and a spring retaining member 46 that is detachably engaging with a lower end portion thereof constitute a shaft portion 44. The shaft main body 45 is supported in the above-described support hole 36A so as to be linearly movable.

The valve body 40 is attached to the base part 11 as follows. The shaft main body 45 is inserted into the support hole 36A from above, and a compression coil spring 49 is inserted into the support sleeve 35 from below. The spring retaining member 46 is pushed into the support sleeve 35 by compressing the compression coil spring 49, and the lower end portion of the shaft main body 45 is inserted into an engagement hole 47. The spring retaining member 46 is rotated with respect to the shaft main body 45, so that the spring retaining member 46 is prevented from coming out of the shaft main body 45. The valve body 40 is biased downward by a resilient force of the compression coil spring 49 sandwiched between the ceiling wall 36 and the spring retaining member 46 both serving as a “spring contact portion”. The flange portion 41F of the valve body 40 comes into close contact with the upper packing 50 to close the valve hole 13. When the valve body 40 receives a pressure exceeding the resilient force of the compression coil spring 49 from the valve hole 13 side and moves upward, the valve hole 13 is opened. As illustrated in FIG. 1, a rotation restricting wall 17A is extended upward from each corner portion of the outer peripheral wall 17 of the base part 11, and the rotation of the valve body 40 about the shaft main body 45 is prevented by the plurality of rotation restricting walls 17A.

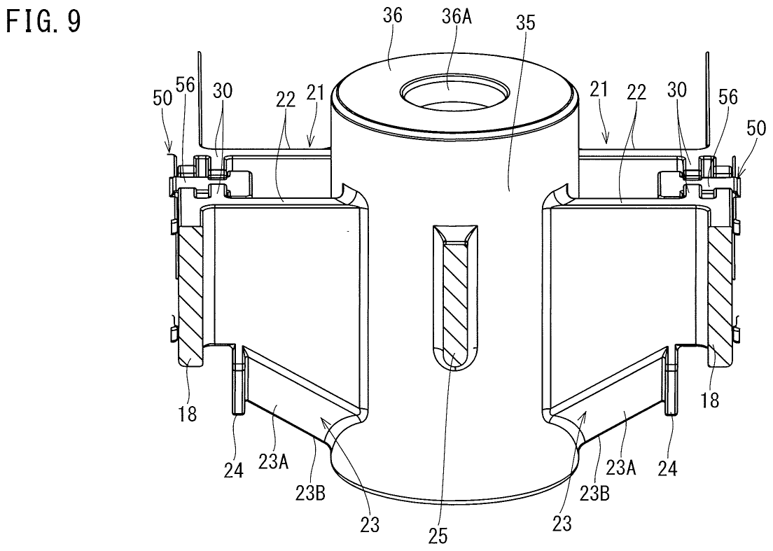

The detailed structures of the first and second support members 21 and 25 that support the support sleeve 35 are as follows. As illustrated in FIG. 4, the first support member 21 is bridged between each of central portions of a pair of long sides of the inner peripheral wall 18 and the support sleeve 35. The first support member 21 includes a pair of flat plate members 22 having a pair of flat-plate shapes facing each other in a direction perpendicular to a penetrating direction of the valve hole 13. The pair of flat plate members 22 is perpendicular to the inner peripheral wall 18 at positions adjacent to both sides of the engagement groove 18A. Upper surfaces of the pair of flat plate members 22 are horizontally flush with an upper surface of the inner peripheral wall 18. On the other hand, as illustrated in FIG. 5, entire lower surfaces of the pair of flat plate members 22 are covered by a shielding member 23 from below except for end portions on the inner peripheral wall 18 side. Specifically, as illustrated in FIG. 9, the end portions on the inner peripheral wall 18 side of the lower surfaces of the pair of flat plate members 22 are horizontally flush with a lower surface of the inner peripheral wall 18. The lower surfaces of the pair of the flat plate member 22 that are covered by the shielding member 23 are inclined downward toward the support sleeve 35.

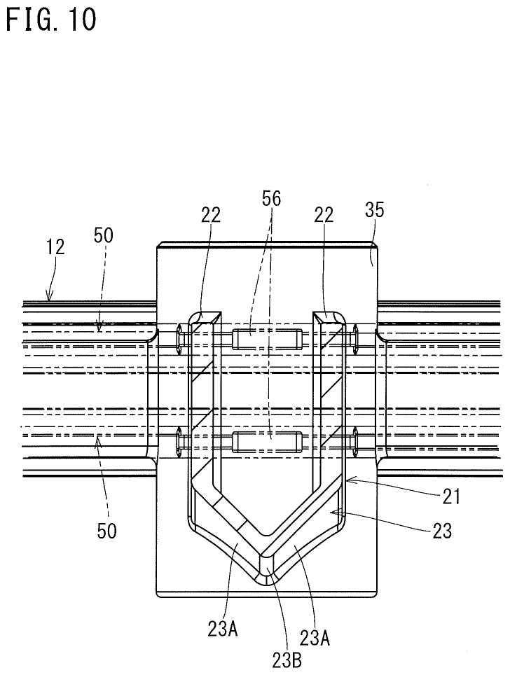

As illustrated in FIG. 10, the shielding member 23 includes a pair of inclined surfaces 23A having a V-groove shape and directed obliquely downward. The pair of inclined surfaces 23A is rounded so as to be slightly recessed, for example. A ridge portion 23B sandwiched between the pair of inclined surfaces 23A extends in a direction inclined with respect to an extending direction of the first support member 21 similarly to the lower surfaces of the pair of flat plate members 22 (see FIG. 9).

The pair of inclined surfaces 23A may be flat inclined surfaces or may be inclined surfaces that gently bulge. The ridge portion 23B extends along the center line of the pair of flat plate members 22, but is not limited to this configuration. For example, the inclined surface 23A is formed to be inclined in one direction from a downward extension of one of the flat plate members 22 toward a lower end of the other flat plate member 22. The ridge portion 23B may extend in a direction perpendicular to the extending direction of the support member 21.

As illustrated in FIGS. 5 and 9, a projecting wall 24 protrudes downward from an entire edge portion of the shielding member 23 on the side close to the inner peripheral wall 18. An end surface of the shielding member 23 facing the inner peripheral wall 18 is flush with a front end of the projecting wall 24.

As illustrated in FIG. 4, the second support member 25 is bridged between each of central portions of a pair of short sides of the inner peripheral wall 18 and the support sleeve 35. The second support member 25 includes a support base portion 26 and a flat plate member 25H. The support base portion 26 has a square groove structure extending in the vertical direction, and is connected to the inner peripheral wall 18 in a state of laterally straddling the pair of engagement grooves 18A arranged on the upper and lower sides at the center of each short side of the inner peripheral wall 18. The flat plate member 25H has a band plate shape whose plate thickness direction is perpendicular to the penetrating direction of the valve hole 13, and extends in a radial direction of the support sleeve 35 from the support sleeve 35, to be connected to the center in a lateral direction of the support base portion 26. Both upper and lower surfaces of the support base portion 26 are horizontally flush with both the upper and lower surfaces of the inner peripheral wall 18. A lower surface of the flat plate member 25H is horizontally flush with the lower surface of the support base portion 26, and an upper surface of the flat plate member 25H is located slightly below the upper surface of the support base portion 26.

As illustrated in FIG. 3, a fitting projection 27 is provided at a position close to the support base portion 26 in a longitudinal direction of the flat plate member 25H. As illustrated in FIG. 5, the fitting projection 27 includes a perpendicular wall 28 extending perpendicular to the flat plate member 25H in a cross shape, from an upper end of the flat plate member 25H to below the flat plate member 25H, and an extension wall 29 extending downward from the flat plate member 25H at a portion adjacent to the perpendicular wall 28 on the support base portion 26 side, and being perpendicular to the perpendicular wall 28 in a T shape. The perpendicular wall 28 has a constant width from its upper end to a position close to its lower end below the flat plate member 25H, and gradually becomes narrower from the position close to the lower end toward the lower end, and its lower end surface is horizontal. The extension wall 29 has a constant width to a position close to its lower end similarly to the perpendicular wall 28, and gradually becomes narrower from the position close to the lower end toward the lower end, and its lower end surface is flush with the lower end surface of the perpendicular wall 28.

As illustrated in FIG. 7(A), 7(B), and 10, the engagement projections 56 of the pair of upper and lower packings 50 described above are accommodated between the pair of flat plate members 22 of the first support member 21 and inside the support base portion 26 of the second support member 25. As illustrated in FIG. 4, a pair of packing retainers 30 is provided on each of opposing surfaces of the pair of flat plate members 22 and opposing surfaces in the support base portion 26 to prevent the engagement projections 56 of the upper packing 50 from moving upward. The pair of packing retainers 30 protrudes so as to approach each other from upper portions of the opposing surfaces of the pair of flat plate members 22 or the like at positions close to the inner peripheral wall 18, and has a plane-symmetrical shape with respect to each other.

The pair of packing retainers 30 in the first support member 21 has a substantially right triangular shape as a whole, and has a structure in which a pair of locking protrusions 30T protrudes so as to further approach each other from distal end portions facing each other as illustrated in FIG. 7(A). An assembly clearance 30Z narrower than the width of the longitudinal portion 56A of each engagement projection 56 is provided between distal ends of the pair of locking protrusions 30T. The pair of packing retainers 30 in the support base portion 26 of the second support member 25 also has the same structure as the pair of packing retainers 30 in the first support member 21 described above. When the upper packing 50 is attached, for example, the packing 50 is received in the packing receiving groove 20A, and the longitudinal portion 56A of the engagement projection 56 is pushed into the assembly clearance 30Z from above. Then, the longitudinal portion 56A is compressed and elastically deformed in a width direction, passes through the assembly clearance 30Z, and is then elastically restored. The pair of locking protrusions 30T overlaps and engages with a top surface (upper surface) of the longitudinal portion 56A and a surface of the head portion 56B facing the proximal end of the engagement projection 56. As a result, the engagement projection 56 is prevented from moving in two directions, namely, a longitudinal direction of the longitudinal portion 56A (a protruding direction of the engagement projection 56) and a direction perpendicular thereto, and the packing 50 is stably held.

The configuration of the present embodiment has been described above. Next, the operational effects of the present embodiment will be described. In the relief valve 10A of the present embodiment, at least the first support member 21 out of the first and second support members 21 and 25 that support the valve body 40 is covered by the shielding member 23 from the battery pack 90 side as illustrated in FIG. 5. Therefore, breakage of the first support member 21 due to high-temperature gas from within the battery pack 90 can be reduced. This makes it possible to make the relief valve 10A function even after discharge of the high-temperature gas, and even if the relief valve 10A cannot function as the originally intended relief valve 10A, it is possible to at least prevent a situation in which the valve body 40 is separated from the base part 11 to leave the valve hole 13 open. That is, with the configuration of the present embodiment, the heat resistance of the relief valve 10A against the high-temperature gas becomes higher than before. In addition, since the shielding member 23 is included in the base part 11, it is possible to easily attach the relief valve 10A to the battery pack 90 as compared with a configuration in which the shielding member 23 is provided separately from the base part 11 and separately fixed to the battery pack 90.

Since the shielding member 23 includes the inclined surfaces 23A inclined with respect to the penetrating direction of the valve hole 13 as illustrated in FIG. 5, the high-temperature gas can be moved away from the support member 21. Moreover, since the inclined surfaces 23A are paired to form a mountain-shaped surface, it is possible to protect both side portions of the first support member 21 by moving away the high-temperature gas toward the opposite sides of the first support member 21. Furthermore, the entirety of the mountain-shaped surface of the shielding member 23 is inclined so as to be away from the battery pack 90 with increasing distance from a central portion of the valve hole 13. Therefore, the high-temperature gas is guided to the side away from the central portion of the valve hole 13 to be smoothly discharged from the valve hole 13 to the outside. Moreover, since the shielding member 23 is extended between the pair of flat plate members 22 forming the first support member 21, the first support member 21 is reinforced by the shielding member 23, and the valve body 40 is stably supported.

In the relief valve 10A of the present embodiment, the shielding member 23 also functions as a “packing retainer cover portion” that covers the packing retainers 30 for preventing the upper packing 50 from lifting, from the battery pack 90 side and the central portion side of the valve hole 13. The support base portion 26 as a part of the second support member 25 also functions as the “packing retainer cover portion”. As a result, the packing retainers 30 are protected from the high-temperature gas, and detachment of the packing 50 due to breakage or damage of the packing retainers 30 is prevented.

The packing retainers 30 of the present embodiment include the pair of locking protrusions 30T facing each other with the assembly clearance 30Z therebetween. Only by inserting the engagement projection 56 of the packing 50 through the assembly clearance 30Z, the pair of locking protrusions 30T engages with the engagement projection 56 in two directions, so that the packing 50 is stably held. Specifically, when the high-temperature gas is discharged from the battery pack 90 side, the upper packing 50 can receive a force in a lifting direction. However, since the pair of locking protrusions 30T overlaps and engages with the longitudinal portion 56A of the engagement projection 56 of the packing 50 from above, and overlaps and engages with the head portion 56B from the proximal end side of the engagement projection 56 (that is, from the packing 50 side). Therefore, the engagement projection 56 is prevented from moving upward together with the packing 50, and the engagement projection 56 is also prevented from being pulled toward the packing 50 and coming out of the pair of locking protrusions 30T. As described above, in the configuration of the present embodiment, it is possible to stably hold the packing 50 while facilitating the attachment work of the packing 50.

When the base part 11 is attached to the battery pack 90, the position of the base part 11 with respect to the battery pack 90 is easily specified by fitting the fitting projections 27 and the shielding members 23 into the gas discharge hole 92 of the battery pack 90, and the attachment work of the base part 11 to the battery pack 90 is facilitated. As described above, the shielding member 23 is also used as a projection for specifying the position of the base part 11 with respect to the battery pack 90, so that the shielding member 23 is effectively used.

In the present embodiment, the shielding member 23 is integrated with the first support member 21, but as in a second embodiment below, a shielding member 61 may be provided at a position away from the first and second support members 21 and 25. In addition, the shielding member 23 may be made of resin, metal, or any other material. However, when the base part 11, the first and second support members 21 and 25, and the shielding member 23 are integrally molded from resin as in the relief valve 10A of the present embodiment, the manufacturing cost can be reduced.

### Second Embodiment

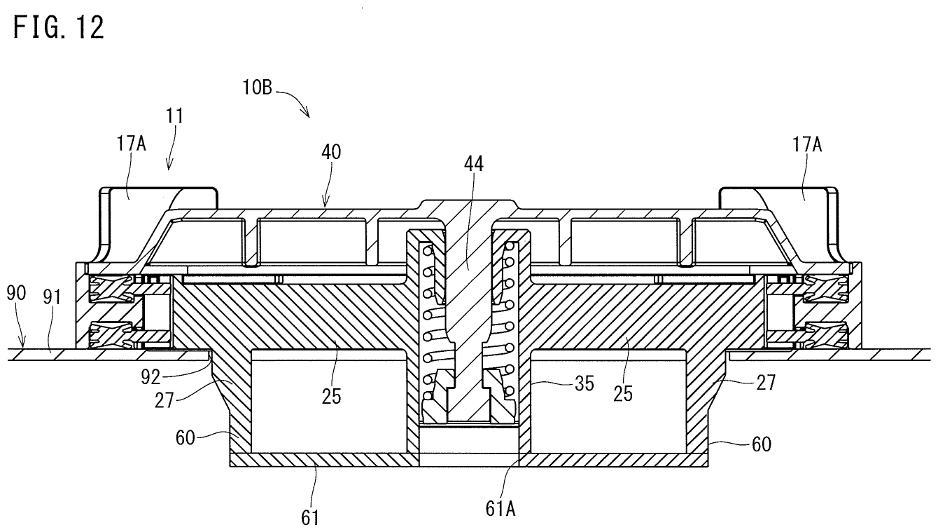

As illustrated in FIG. 12, a relief valve 10B of the present embodiment has a structure in which the relief valve 10A of the first embodiment is additionally provided with a shielding member 61. The shielding member 61 has a structure in which a through hole 61A is formed in a center portion of its oval flat surface that is slightly smaller than the planar shape of the discharge hole 92 of the battery pack 90. In order to support the shielding member 61, a pair of support portions 60 is extended downward from the pair of fitting projections 27, and the support sleeve 35 is extended to a position where a lower surface of the support sleeve 35 has the same height as lower ends of the pair of support portions 60. The shielding member 61 is extended between the lower ends of the pair of support portions 60 and a lower end of the support sleeve 35. The shielding member 61 may be welded to the lower ends of the support portions 60 and the support sleeve 35.

According to the configuration of the present embodiment, the first and second support members 21 and 25 are covered from the battery pack 90 side, and the first and second support members 21 and 25 are protected from the high-temperature gas generated in the battery pack 90.

The relief valve 10B of the present embodiment includes the shielding member 61 in addition to the shielding member 23 described in the first embodiment, but may include only the shielding member 61.

### Third Embodiment

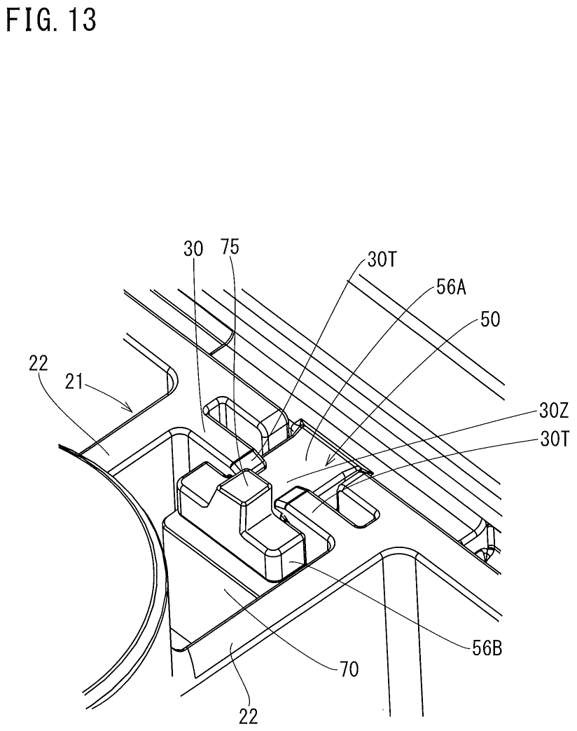

Hereinafter, a relief valve 10F according to a third embodiment will be described with reference to FIGS. 13 to 15. As illustrated in FIG. 13, the relief valve 10F of the present embodiment is different from the relief valve 10A of the first embodiment in that the support member 21 is provided with a bending restricting portion 70 and in that the engagement projection 56 is provided with a pressing projection 75.

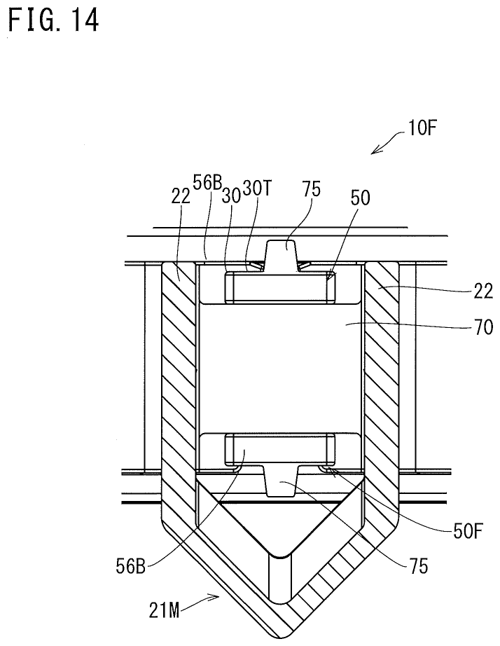

As illustrated in FIG. 14, the bending restricting portion 70 is bridged between the pair of flat plate members 22 of the support member 21. An upper surface of the bending restricting portion 70 is laid on a back surface of the head portion 56B of the engagement projection 56 of the upper packing 50, from below, while a lower surface of the bending restricting portion 70 is laid on a back surface of the head portion 56B of the lower packing 50, from above.

As illustrated in FIG. 13, the pressing projection 75 protrudes from a top surface of the head portion 56B of the packing 50. The pressing projection 75 is disposed at a longitudinal center position of the head portion 56B, and has a width that fits between the distal ends of the pair of locking protrusions 30T. When the packing 50 is attached, the packing 50 is received in the packing receiving groove 20A, and the longitudinal portion 56A of the engagement projection 56 is pushed so as to pass through the assembly clearance 30Z as described in the first embodiment. By pressing the pressing projection 75 at this stage, the longitudinal portion 56A can be easily pushed into the assembly clearance 30Z.

The pressing projection 75 may be provided on the longitudinal portion 56A. The pressing projection 75 may also be disposed at a position that fits in the assembly clearance 30Z. In addition, the pressing projection 75 may be wider than the assembly clearance 30Z. Furthermore, on a top surface of the engagement projection 56, the entire head portion 56B may protrude stepwise from the longitudinal portion 56A to form the pressing projection 75. The pair of locking protrusions 30T may overlap and engage with the head portion 56B including the pressing projection 75 from the proximal end side of the engagement projection 56.

According to the configuration of the present embodiment, the packing 50 is more strongly held as compared with the first embodiment. Specifically, when a large amount of high-temperature gas is discharged in a single burst from the battery pack 90 side and a force for lifting the upper packing 50 becomes abnormally large, the engagement protrusion 56 may move rotationally about the pair of locking protrusions 30T as a fulcrum, and the head portion 56B may descend and disengage from the pair of locking protrusions 30T in a structure without the bending restricting portion 70. It is assumed that the head portion 56B resultantly passes under the pair of locking protrusions 30T, the engagement projection 56 is pulled toward the packing 50 to come out of the pair of locking protrusions 30T, and the packing 50 is detached. On the other hand, in the present embodiment, the rotation of the engagement projection 56 about the packing retainers 30 as a fulcrum is prevented by providing the bending restricting portion 70. Accordingly, the occurrence of the above-described situation can be reduced, and the packing 50 is strongly held.

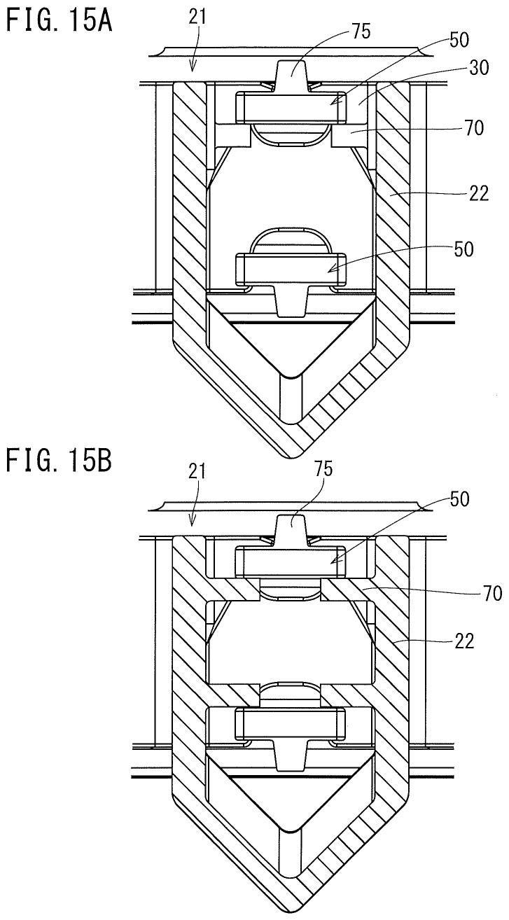

The bending restricting portion 70 may be provided separately for each of the upper and lower packings 50, or may be provided only for the upper packing 50. Although the bending restricting portion 70 is bridged between the pair of flat plate members 21, the bending restricting portion is not limited to this configuration. For example, as illustrated in FIG. 15B, the bending restricting portion may protrude from the pair of flat plate members 22 in a cantilevered manner. For example, as illustrated in FIG. 15A, the bending restricting portion may protrude from the pair of locking protrusions 30T toward the central side of the relief valve 10F (a direction perpendicular to the paper surface). Moreover, the packing 50 of the present embodiment includes the pressing projection 75, but does not have to include the pressing projection 75.

### Third Embodiment

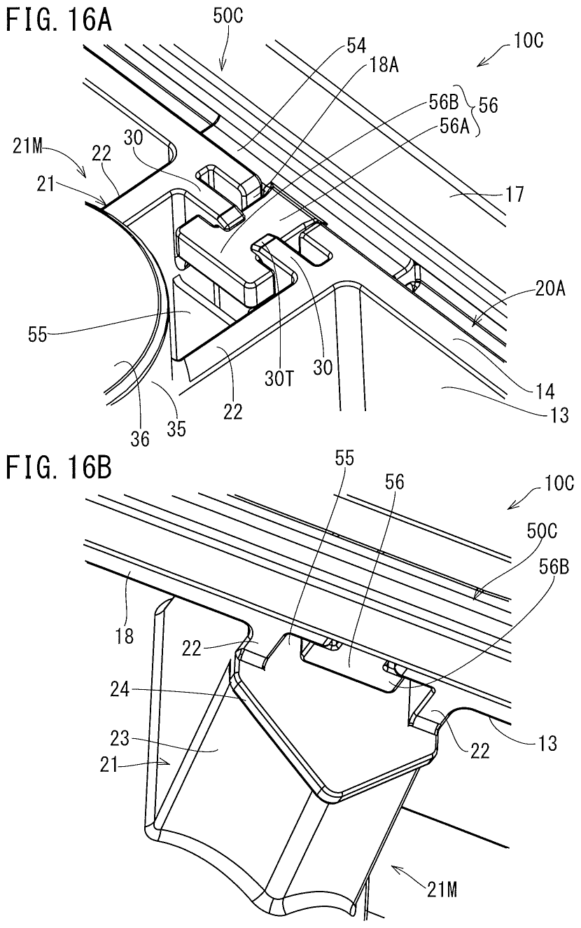

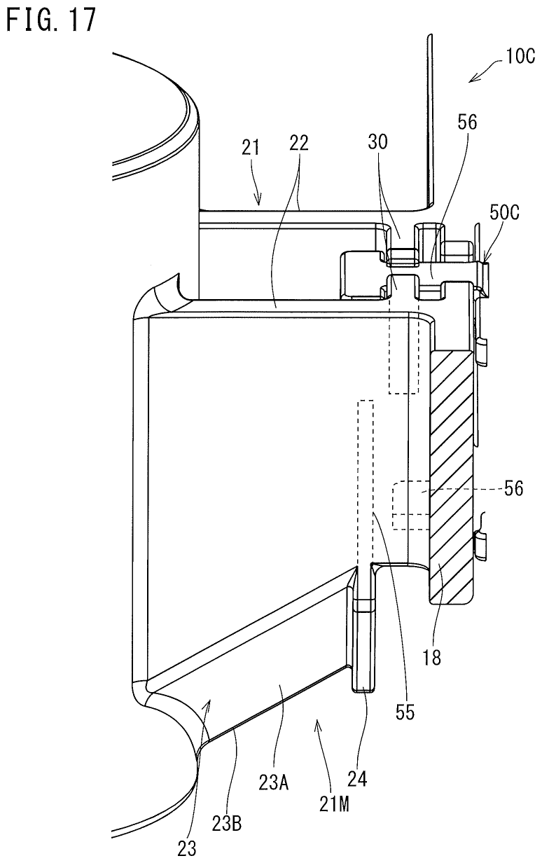

Hereinafter, a relief valve 10C according to a third embodiment will be described with reference to FIGS. 16 and 17. As illustrated in FIG. 16B, the relief valve 10C of the present embodiment is different from the relief valve 10A of the first embodiment in that a closing wall 55 is provided at an end portion of a groove-shaped structure portion 21M formed by the pair of flat plate members 22 and the shielding member 23.

Specifically, the closing wall 55 has a flat plate shape, is located at an end portion of the shielding member 23 on the inner peripheral wall 18 side (that is, an end portion on the side away from the central portion of the valve hole 13), and is disposed in parallel with the inner peripheral wall 18 with a gap therebetween. An end opening of the groove-shaped shielding member 23 is closed by a lower portion of the closing wall 55. As illustrated in FIGS. 16B and 17, an entire lower edge portion of the closing wall 55 is extended so as to protrude from the shielding member 23 to serve as the above-described projecting wall 24.

As illustrated in FIG. 13A, a portion of the closing wall 55 above the shielding member 23 is extended between the pair of flat plate members 22. An upper end of the closing wall 55 is located slightly below the packing retainers 30 between the pair of flat plate members 22.

Since the closing wall 55 is provided at each of the end portions of both the shielding members 23, the longitudinal portions 56A (see FIG. 6) of the pair of engagement projections 56 at the intermediate portions in the longitudinal direction of the lower packing 50 are shorter than those of the first embodiment, to avoid interference with the closing walls 55.

According to the configuration of the present embodiment, the closing wall 55 can reduce inflow of the high-pressure gas toward the flat plate members 22 (the support member 21).

### Fourth Embodiment

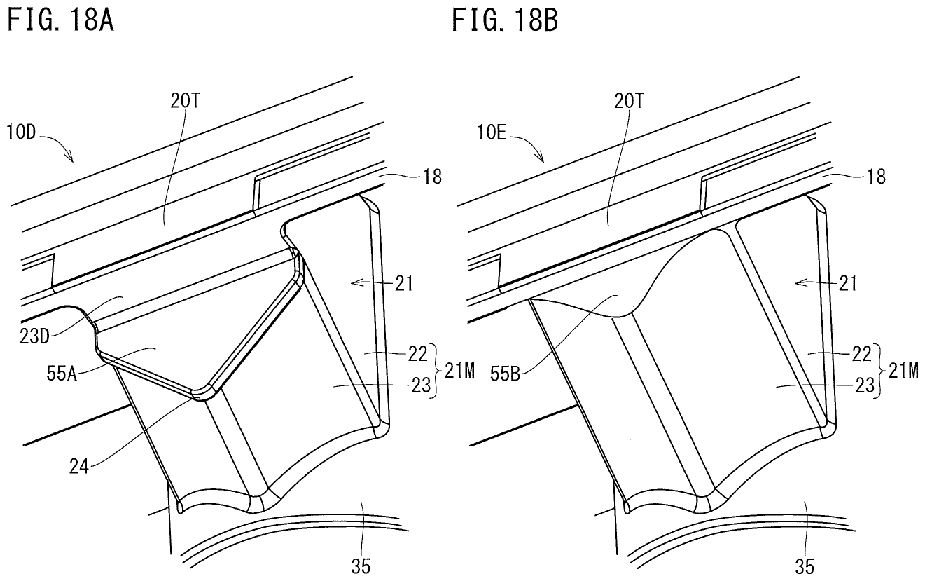

As illustrated in FIG. 18A, a relief valve 10D of the present embodiment is different from the relief valve 10C of the third embodiment in the structure of a closing wall 55A. That is, the closing wall 55A of the present embodiment is disposed below the pair of flat plate members 22 to close the entire end opening of the shielding member 23. An opening surrounded by the closing wall 55A, the pair of flat plate members 22, and the inner peripheral wall 18 is closed by a second shielding member 23D.

An outer edge portion of the closing wall 55A serves as the projecting wall 24 as in the third embodiment. Since the second shielding member 23D is provided, the pair of engagement projections 56 at the intermediate portions in the longitudinal direction of the lower packing 50 (not illustrated in FIG. 18A; see FIG. 6) is eliminated.

According to the configuration of the present embodiment as well, the closing wall 55A can reduce inflow of the high-pressure gas toward the flat plate members 22 (the support member 21).

### Fifth Embodiment

A relief valve 10E of the present embodiment is illustrated in FIG. 18B, and is different from the above fourth embodiment in that the shielding member 23 extends so as to reach the inner peripheral wall 18, and a closing wall 55B that closes the end opening of the shielding member 23 is also connected to the inner peripheral wall 18, and in that the projecting wall 24 is not provided.

### Other Embodiments

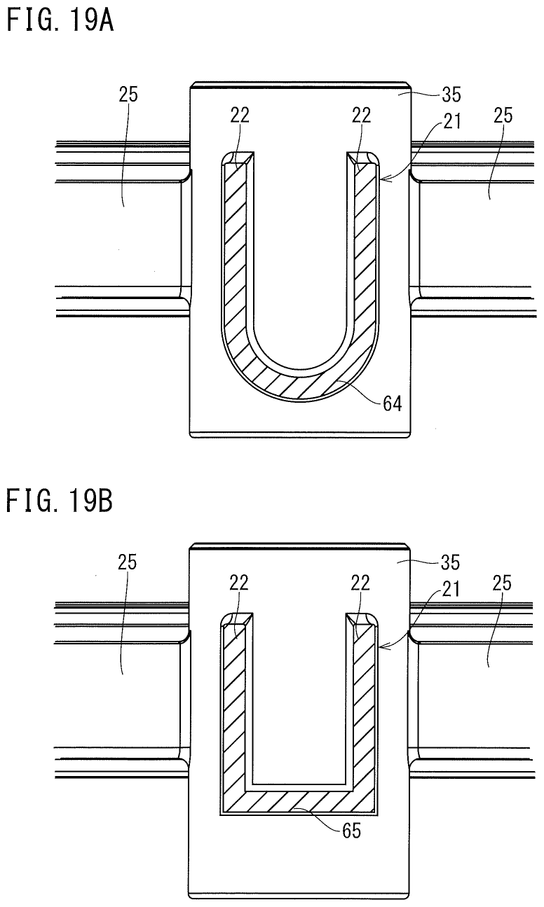

FIGS. 19A and 19B illustrate modifications of the relief valve 10A of the first embodiment, and the relief valves of these modifications include shielding members 64 and 65 having shapes different from that of the shielding member 23 of the first embodiment. Specifically, the shielding member 64 illustrated in FIG. 19A has a groove structure having a U-shaped cross section, and is extended between lower end portions of the pair of flat plate members 22 included in the first support member 21. On the other hand, the shielding member 65 illustrated in FIG. 19B has a flat plate shape, and is extended between the lower end portions of the pair of flat plate members 22.

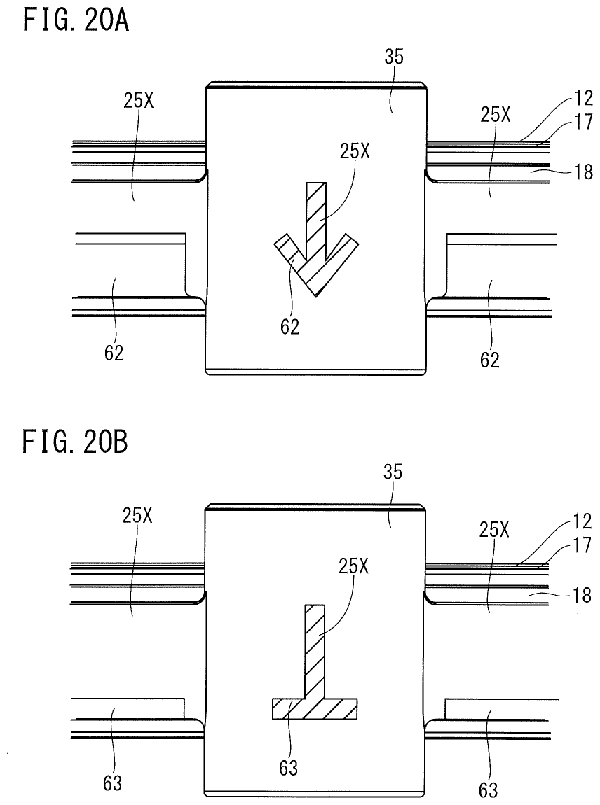

FIGS. 20A and 20B illustrate modifications of the relief valve 10A of the first embodiment, and the relief valves of these modifications have a structure in which support members 25X having a structure similar to that of the second support member 25 included in the relief valve 10A of the first embodiment extend in four directions from the support sleeve 35. Shielding members 62 and 63 are provided at a lower end portion of each support member 25X. Specifically, the shielding member 62 illustrated in FIG. 20A has a V-shaped cross section, and has a structure in which the lower end portion of the support member 25X is connected to a central portion of the V shape of the shielding member 62. On the other hand, the shielding member 63 illustrated in FIG. 20B has a flat plate shape, and has a structure in which the lower end portion of the support member 25X is connected to its central portion in a width direction. In a case where the support member 25X and the shielding member 62 do not form a groove-shaped structure portion, but the single shielding member 62 itself has a groove-shaped structure as illustrated in FIG. 20A, an end opening of the shielding member 62 may be closed by a closing wall to reduce inflow of the high-temperature gas toward the support member 25X similarly to the fourth and fifth embodiments.

Although the support member 25X is bridged from the center of the long side and the center of the short side of the valve hole 13 to the support sleeve 35, the support member is not limited to this configuration, and the support member may be bridged from the four corners of the valve hole 13 to the support sleeve 35. In addition, the lower end portion of the support member 25X may be connected to one end in the width direction of the shielding member 63.

### Supplementary Note

Hereinafter, a feature group extracted from the above embodiments will be described while showing the effects and the like as necessary. It should be noted that the reference signs of corresponding components in the above embodiments are appropriately indicated in parentheses or the like below for easy understanding, but the feature group is not limited to the specific components specified by the reference signs indicated in the parentheses or the like.

### Feature 1

A relief valve (10A) including: a base part (11) fixed to a battery pack (90) and having a valve hole (13) configured to discharge gas in the battery pack (90) to outside; a support member (21, 25) included in the base part (11) and extending from an inner surface or an opening edge of the valve hole (13) into the valve hole (13) or an extended space of the valve hole (13); a valve body (40) covering the valve hole (13) from an outer side, supported by the support member (21, 25), and configured to operate so as to move away from the valve hole (13) to the outer side in response to an increase in pressure in the battery pack (90); and a shielding member (23) included in the base part (11) and covering the support member (21) from the battery pack (90) side.

In the relief valve of the feature 1, since the support member that supports the valve body is covered by the shielding member from the battery pack side, breakage of the support member due to high-temperature gas is reduced. This makes it possible to make the relief valve function even after discharge of the high-temperature gas. Furthermore, even if the relief valve cannot function as originally intended, it is still possible to at least prevent a situation in which the valve body is separated from the base part thereby to leave the valve hole open. That is, with the configuration of the feature 1, the heat resistance of the relief valve against the high-temperature gas becomes higher than before. In addition, since the shielding member is included in the base part, it is possible to easily attach the relief valve to the battery pack as compared with a configuration in which the shielding member and the base part are provided separately and fixed to the battery pack separately.

In a case where a plurality of the support members are provided, all of the plurality of support members may be covered with the shielding member, or only some of the support members may be supported by the shielding member.

### Feature 2

The relief valve (10A) according to the feature 1, wherein the shielding member (23) includes an inclined surface (23A) facing the battery pack (90) and inclined with respect to a penetrating direction of the valve hole (13).

According to the configuration of the feature 2, the high-temperature gas can be moved away from the support member by the inclined surface provided in the shielding member.

### Feature 3

The relief valve (10A) according to the feature 1 or 2, wherein the shielding member (23) includes a mountain-shaped surface (23A) protruding toward the battery pack (90) and having a ridge portion (23B) extending in a longitudinal direction of the support member (21).

In the relief valve of the feature 3, since the shielding member includes the mountain-shaped surface, it is possible to protect both side portions of the support member by moving away the high-temperature gas toward the opposite sides of the support member.

### Feature 4

The relief valve (10A) according to the feature 3, wherein an entirety of the mountain-shaped surface (23A) is inclined to be away from the battery pack (90) with increasing distance from a central portion of the valve hole (13).

In the relief valve of the feature 4, the entirety of the mountain-shaped surface of the shielding member is inclined so as to be away from the battery pack with increasing distance from the central portion of the valve hole. Therefore, the high-temperature gas is guided to the side away from the central portion of the valve hole to be smoothly discharged from the valve hole to the outside.

### Feature 5

The relief valve (10A) according to any one of the features 1 to 4, wherein the shielding member (23) has a groove-shaped structure having a V-shaped cross section or a U-shaped cross section and extending along the support member (21, 25).

In the relief valve of the feature 5, since the shielding member has a V-shaped cross section or a U-shaped cross section, it is possible to protect the both side portions of the support member by moving away the high-temperature gas toward the opposite sides of the support member.

### Feature 6

The relief valve (10C) according to the feature 5, including a closing wall (55, 55A, 55B) configured to close at least a part of a groove end portion of the shielding member (23) having the groove-shaped structure, on a side away from a central portion of the valve hole (13).

In the relief valve of the feature 6, since the closing wall is provided, it is possible to reduce inflow of the high-temperature gas toward a flat plate member (the support member).

### Feature 7

The relief valve (10A) according to any one of the features 1 to 6, wherein the support member (21) includes a pair of flat plate members (22) extending from the inner surface of the valve hole (13) toward a central portion of the valve hole (13) and facing each other in a direction perpendicular to a penetrating direction of the valve hole (13), and the shielding member (23) is extended between the pair of flat plate members (22).

According to the configuration of the feature 7, the support member is reinforced by the shielding member, and the valve body is stably supported.

### Feature 8

The relief valve (10C) according to the feature 7, wherein a closing wall (55) having a flat plate shape and facing the inner surface of the valve hole (13) is extended between the pair of flat plate members at positions close to end portions of the pair of flat plate members (22) on a side away from the central portion of the valve hole (13), and one end portion of the shielding member (23) is disposed away from the inner surface of the valve hole (13), and the one end portion of the shielding member (23) is connected to the closing wall (55).

According to the feature 8, since the closing wall is provided, it is possible to reduce inflow of the high-temperature gas toward the flat plate members (the support member).

### Feature 9

The relief valve (10A) according to any one of the features 1 to 8, including: a packing (50) laid on the opening edge of the valve hole (13) in the base part (11); an engagement projection (56) protruding from the packing (50) into the valve hole (13); and a packing retainer (30) provided in the base part (11) to engage with the engagement projection (56), and configured to prevent the packing (13) from lifting.

According to the feature 9, it is possible to prevent the packing from lifting from the opening edge of the valve hole due to the high-temperature gas. The packing retainer may have, for example, a groove shape into which the engagement projection is press-fitted, a beam shape extending in a direction perpendicular to a protruding direction of the engagement projection to allow the engagement projection to get under and engage with the packing retainer, or a structure as in the feature 10 described below.

### Feature 10

The relief valve (10A) according to the feature 9, wherein the base part (11) is provided with a pair of opposing walls (22) facing each other with the engagement projection (56) interposed between the opposing walls (22) in a width direction, the packing retainer (30) includes a pair of locking protrusions (30T) protruding from the pair of opposing walls (22) to approach each other and having an assembly clearance (30Z) between distal ends of the locking protrusions (30T), the assembly clearance (30Z) allowing the engagement projection (56) to pass through the assembly clearance (30Z) by compressing and deforming the engagement projection (56) in the width direction, and the pair of locking protrusions (30T) engages with a top surface of the engagement projection (56) having passed through the assembly clearance (30Z).

According to the feature 10, the engagement projection is compressed and deformed in the width direction, passes through the assembly clearance between the pair of locking protrusions, and is elastically restored, so that the pair of locking protrusions engages with the engagement projection. In this manner, the packing retainer can be easily engaged with the engagement projection.

### Feature 11

The relief valve (10F) according to the feature 10, including a pressing projection (75) protruding from the top surface of the engagement projection (56).

According to the feature 10, since the engagement projection can be pushed into the assembly clearance by pressing the pressing projection, the attachment work of the packing is facilitated.

### Feature 12

The relief valve (10A) according to the feature 10 or 11, wherein the engagement projection (56) includes a head portion (56B) obtained by increasing a width of a distal end portion of the engagement projection, and the pair of locking protrusions (30T) engages with the engagement projection (56) on a proximal end side relative to the head portion (56B) and overlaps and engages with the head portion (56B) from the proximal end side of the engagement projection (56).

According to the feature 12, the pair of locking protrusions prevents the engagement projection from moving in two directions of the protruding direction from the packing and a direction perpendicular thereto. As a result, the packing is stabilized.

### Feature 13

The relief valve (10F) according to the feature 12, including a bending restricting portion (70) bridged between the pair of opposing walls (22) and laid on a back surface of the head portion (56B).

In the above-described configuration of the feature 12, in a case where a large force is applied in a lifting direction of the packing, there is a concern that the engagement projection moves rotationally about the pair of locking protrusions as a fulcrum, and the engagement between the pair of locking protrusions and the engagement projection is loosened. To cope with this, according to the configuration of the feature 13, by providing the bending restricting portion laid on the back surface of the head portion, the rotation of the engagement projection is prevented, and the engagement between the pair of locking protrusions and the engagement projection is strengthened.

### Feature 14

The relief valve (10F) according to any one of the features 10 to 12, including a bending restricting portion (70) formed in the base part (11) and laid on a back surface of the engagement projection (56).

As in the feature 14, the bending restricting portion may be provided regardless of the presence or absence of the head portion.

### Feature 15

The relief valve (10A) according to any one of the features 9 to 14, including a packing retainer cover portion (26) provided in the base part (11) to cover the packing retainer (30) from the battery pack (90) side or from a central portion side of the valve hole (13).

In the relief valve of the feature 15, since the packing retainer is covered with the packing retainer cover portion and protected from the high-temperature gas, detachment of the packing due to breakage or damage of the packing retainer is prevented.

### Feature 16

The relief valve (10A) according to any one of the features 1 to 15, wherein a plurality of the support members (21, 25) are provided radially around a central portion of the valve hole (13), a plurality of fitting projections (23, 27) protruding from the plurality of support members (21, 25) toward the battery pack (90) and fitted into a gas discharge hole of the battery pack (90) are provided, and at least one of the plurality of fitting projections (23, 27) also serves as the shielding member (23).

According to the relief valve of the feature 16, when the base part is attached to the battery pack, the position of the base part with respect to the battery pack is easily specified by fitting the plurality of fitting projections into the gas discharge hole of the battery pack, and the attachment work of the base part to the battery pack is facilitated. In addition, at least one of the plurality of fitting projections also serves as the shielding member, so that the fitting projection is effectively used.

### Feature 17

The relief valve (10A) according to any one of the features 1 to 16, including: a shaft portion (44) protruding from the valve body (40) toward the valve hole (13); a support sleeve (35) supported by the support member (21, 25) and into which the shaft portion (44) is fitted to be linearly movable; and a compression coil spring (49) fitted between the shaft portion (44) and the support sleeve (35) and sandwiched between a pair of spring contact portions (36, 46) in an axial direction of the shaft portion (44), the spring contact portions (36, 46) respectively protruding from the shaft portion (44) and the support sleeve (35), the compression coil spring (49) being configured to bias the valve body (40) toward the valve hole (13).

As the structure in which the valve body is supported by the support member, the structure as in the feature 17 may be adopted, or for example, a structure may be adopted in which the entire valve body is an elastic body, which is elastically deformed so as to be turned up by the pressure from within the battery pack to open the valve hole.

### Feature 18

The relief valve according to any one of the features 1 to 17, wherein the base part (11), the support member (21, 25), and the shielding member (23) are integrally molded from resin.

According to the feature 18, since the base part, the support member, and the shielding member are integrally molded from resin, the manufacturing cost of the relief valve can be reduced.

Although specific examples of the technique included in the claims are disclosed in the present specification and the drawings, the technique described in the claims is not limited to these specific examples, and includes those obtained by variously modifying or changing the specific examples, and also includes those obtained by singly extracting a part from the specific examples.

### DESCRIPTION OF THE REFERENCE NUMERALS

10A to 10F Relief valve
11 Base part
13 Valve hole
21 First support member
25, 25X Second support member
22 Flat plate member
23, 23D, 62 to 65 Shielding member (packing retainer cover portion, fitting projection)
23A Inclined surface (mountain-shaped surface)
23B Ridge portion
26 Support base portion (packing retainer cover portion)
27 Fitting projection
30 Packing retainer
30Z Assembly clearance
35 Support sleeve
36 Ceiling wall (spring contact portion)
40 Valve body
46 Spring retaining member (spring contact portion)
49 Compression coil spring
50 Packing
55, 55A, 55B Closing wall
56 Engagement projection
56B Head portion
61 to 65 Shielding member
70 Bending restricting portion
75 Pressing projection
90 Battery pack
91 Upper wall
92 Discharge hole

1. A relief valve comprising:
a base part fixed to a battery pack and having a valve hole configured to discharge gas in the battery pack to outside;
a support member included in the base part and extending from an inner surface or an opening edge of the valve hole into the valve hole or an extended space of the valve hole;
a valve body covering the valve hole from an outer side, supported by the support member, and configured to operate so as to move away from the valve hole to the outer side in response to an increase in pressure in the battery pack; and
a shielding member included in the base part and covering the support member from the battery pack side.

2. The relief valve according to claim 1, wherein the shielding member includes an inclined surface facing the battery pack and inclined with respect to a penetrating direction of the valve hole.

3. The relief valve according to claim 1, wherein the shielding member includes a mountain-shaped surface protruding toward the battery pack and having a ridge portion extending in a longitudinal direction of the support member.

4. The relief valve according to claim 3, wherein an entirety of the mountain-shaped surface is inclined to be away from the battery pack with increasing distance from a central portion of the valve hole.

5. The relief valve according to claim 1, wherein the shielding member has a groove-shaped structure having a V-shaped cross section or a U-shaped cross section and extending along the support member.

6. The relief valve according to claim 5, comprising a closing wall configured to close at least a part of a groove end portion of the shielding member having the groove-shaped structure, on a side away from a central portion of the valve hole.

7. The relief valve according to claim 1, wherein
the support member includes a pair of flat plate members extending from the inner surface of the valve hole toward a central portion of the valve hole and facing each other in a direction perpendicular to a penetrating direction of the valve hole, and
the shielding member is extended between the pair of flat plate members.

8. The relief valve according to claim 7, wherein
a closing wall having a flat plate shape and facing the inner surface of the valve hole is extended between the pair of flat plate members at positions close to end portions of the flat plate members on a side away from a central portion of the valve hole, and
one end portion of the shielding member is disposed away from the inner surface of the valve hole, and the one end portion of the shielding member is connected to the closing wall.

9. The relief valve according to claim 1, comprising:
a packing laid on the opening edge of the valve hole in the base part;
an engagement projection protruding from the packing into the valve hole; and
a packing retainer provided in the base part to engage with the engagement projection, and configured to prevent the packing from lifting.

10. The relief valve according to claim 9, wherein
the base part is provided with a pair of opposing walls facing each other with the engagement projection interposed between the opposing walls in a width direction,
the packing retainer includes a pair of locking protrusions protruding from the pair of opposing walls to approach each other and having an assembly clearance between distal ends of the locking protrusions, the assembly clearance allowing the engagement projection to pass through the assembly clearance by compressing and deforming the engagement projection in the width direction, and
the pair of locking protrusions engages with a top surface of the engagement projection having passed through the assembly clearance.

11. The relief valve according to claim 10, comprising a pressing projection protruding from the top surface of the engagement projection.

12. The relief valve according to claim 10, wherein the engagement projection includes a head portion obtained by increasing a width of a distal end portion of the engagement projection, and the pair of locking protrusions engages with the engagement projection on a proximal end side relative to the head portion and overlaps and engages with the head portion from the proximal end side of the engagement projection.

13. The relief valve according to claim 12, comprising a bending restricting portion bridged between the pair of opposing walls and laid on a back surface of the head portion.

14. The relief valve according to claim 10, comprising a bending restricting portion formed in the base part and laid on a back surface of the engagement projection in the engagement projection.

15. The relief valve according to claim 9, comprising
a packing retainer cover portion provided in the base part to cover the packing retainer from the battery pack side or from a central portion side of the valve hole.

16. The relief valve according to claim 1, wherein
a plurality of the support members are provided radially around a central portion of the valve hole,
a plurality of fitting projections protruding from the plurality of support members toward the battery pack and fitted into a gas discharge hole of the battery pack are provided, and
at least one of the plurality of fitting projections also serves as the shielding member.

17. The relief valve according to claim 1, comprising:
a shaft portion protruding from the valve body toward the valve hole;
a support sleeve supported by the support member and into which the shaft portion is fitted to be linearly movable; and
a compression coil spring fitted between the shaft portion and the support sleeve and sandwiched between a pair of spring contact portions in an axial direction of the shaft portion, the spring contact portions respectively protruding from the shaft portion and the support sleeve, the compression coil spring being configured to bias the valve body toward the valve hole.

18. The relief valve according to claim 1, wherein the base part, the support member, and the shielding member are integrally molded from resin.

19. The relief valve according to claim 11, wherein the engagement projection includes a head portion obtained by increasing a width of a distal end portion of the engagement projection, and the pair of locking protrusions engages with the engagement projection on a proximal end side relative to the head portion and overlaps and engages with the head portion from the proximal end side of the engagement projection.

20. The relief valve according to claim 19, comprising a bending restricting portion bridged between the pair of opposing walls and laid on a back surface of the head portion.
